(19) United States
(12) Patent Application Publication
(10) Pub. No.: US 2017/0001550 A1
(43) Pub. Date: Jan. 5, 2017

(54) VEHICLE TRANSPORTATION APPARATUS

(71) Applicant: James M. Morgan, Texarkana, TX (US)

(72) Inventor: James M. Morgan, Texarkana, TX (US)

(21) Appl. No.: 14/755,108

(22) Filed: Jun. 30, 2015

(51) Int. Cl. B60P 1/43; B65G 69/30

(52) U.S. Cl. CPC B60P 1/43; B65G 69/30

(57) ABSTRACT

Apparatus for transporting smaller vehicles using a larger vehicle includes a single-gradient, semi-flexible supporting structure and an attachment mechanism coupling the supporting structure to the larger vehicle. The supporting structure is at an angle with respect to the larger vehicle and is suspended in air in close proximity to but without touching the ground, allowing the smaller vehicle to be loaded, transported, and unloaded without having to stow, store, fold, adjust, unhitch, remove, assemble, or otherwise alter or move the apparatus. The vehicle transportation apparatus provides an efficient solution for transporting smaller vehicles using a larger one that is safe to drive; requires no assembly, adjustment, storage, or removal between loading, transporting, and unloading; and allows a truck or utility vehicle owner to easily carry smaller vehicles without the typical hassle, inconvenience, risk, complexity, or inefficiency of current systems.

### BACKGROUND OF THE INVENTION

Field of the Invention

Embodiments of the invention disclosed herein relate generally to transportation of smaller vehicles using a larger one. More specifically, the invention relates to a more efficient apparatus for easily loading, transporting, and unloading smaller vehicles using trucks and other utility vehicles.

Description of Related Art

For many years, trucks and other utility vehicles have been used for transporting smaller vehicles, such as ATVs, motorcycles, and off-road vehicles. Generally, there are three traditional methods of transporting smaller vehicles using a larger one.

First, if the truck or utility vehicle has a long enough bed, the smaller vehicle can be loaded directly onto the bed of the larger vehicle. However, pickup trucks have a truck bed that is typically only around six to seven feet long, and extended cab pickup trucks and many utility vehicles may have an even shorter storing and transporting area. Many times, smaller vehicles are unable to fit into the bed of a truck or utility vehicle without the requirement of other apparatus. Compounding the problem, some trucks also have a toolbox behind the cab that can take up to 18 inches or more.

Second, if a truck or utility vehicle has the necessary towing capabilities, a large wheeled platform or trailer bed can be attached to the truck or utility vehicle, and the smaller vehicle can be transported on the trailer bed. However, trailers can be dangerous to maneuver when driving, and they require extra stopping room and additional precautions to avoid collisions. Additionally, trailer beds typically require their own brake light and signaling light system, which must be connected using wires attached to the main vehicle. Setting up these lighting systems correctly takes much time and effort and increases the cost of owning the smaller vehicle. And trailers have the additional expense in some states of requiring a trailer license that must be renewed every year.

Lastly, some truck or utility vehicles have incorporated a hybrid-type trailer system that attaches to the back of the vehicle and allows for a smaller vehicle to be transported without a full trailer bed. However, the current hybrid trailer systems are complicated and inefficient. They typically are constructed using several sets of ramps or gradients connected together that must be assembled before loading; adjusted, stored, or removed for transportation; and then reassembled for unloading.

Because of the current lack of solutions in the industry generally, it is desirable to have an efficient solution that is safe to drive; requires no assembly, adjustment, storage, or removal between loading, transporting, and unloading; and allows a truck or utility vehicle owner to easily carry smaller vehicles without the typical hassle, inconvenience, risk, complexity, or inefficiency of current systems.

### SUMMARY OF THE INVENTION

In accordance with the embodiments disclosed herein, a small vehicle transportation apparatus is provided that substantially eliminates or reduces the disadvantages and problems associated with previous systems. The vehicle transportation apparatus comprises, among other things, a single-gradient, semi-flexible supporting structure and an attachment mechanism coupling the supporting structure to the larger vehicle. The supporting structure is at an angle with respect to the larger vehicle and the ground and is suspended in the air a predefined distance above the ground. Such a vehicle transportation apparatus allows the smaller vehicle to be loaded, transported, and unloaded without having to stow, store, fold, adjust, unhitch, remove, assemble, or otherwise alter or move the apparatus.

The novel features and construction of the vehicle transportation apparatus disclosed herein, as well as additional objects thereof, will be understood more fully from the following description when read in connection with the accompanying drawings.

### BRIEF DESCRIPTION OF THE DRAWINGS

For a more complete understanding of the disclosed embodiments and its advantages, reference is now made to the following description taken in conjunction with the accompanying drawings, in which like reference numbers indicate like features, wherein:

FIG. 1 is a perspective view of a vehicle transportation apparatus attached to a larger vehicle and supporting a smaller vehicle according to embodiments disclosed herein;

FIG. 2 is a side view of the vehicle transportation apparatus according to embodiments disclosed herein;

FIG. 3 is a perspective view of a support strut for the vehicle transportation apparatus according to embodiments disclosed herein;

FIG. 4 is a bottom view of a standard receiver hitch with the support strut of the vehicle transportation apparatus inserted therein according to embodiments disclosed herein;

FIG. 5 is a rear view of the vehicle transportation apparatus according to embodiments disclosed herein; and

FIG. 6 is a rear view of an alternative vehicle transportation apparatus according to embodiments disclosed herein.

### DESCRIPTION OF THE PREFERRED EMBODIMENTS

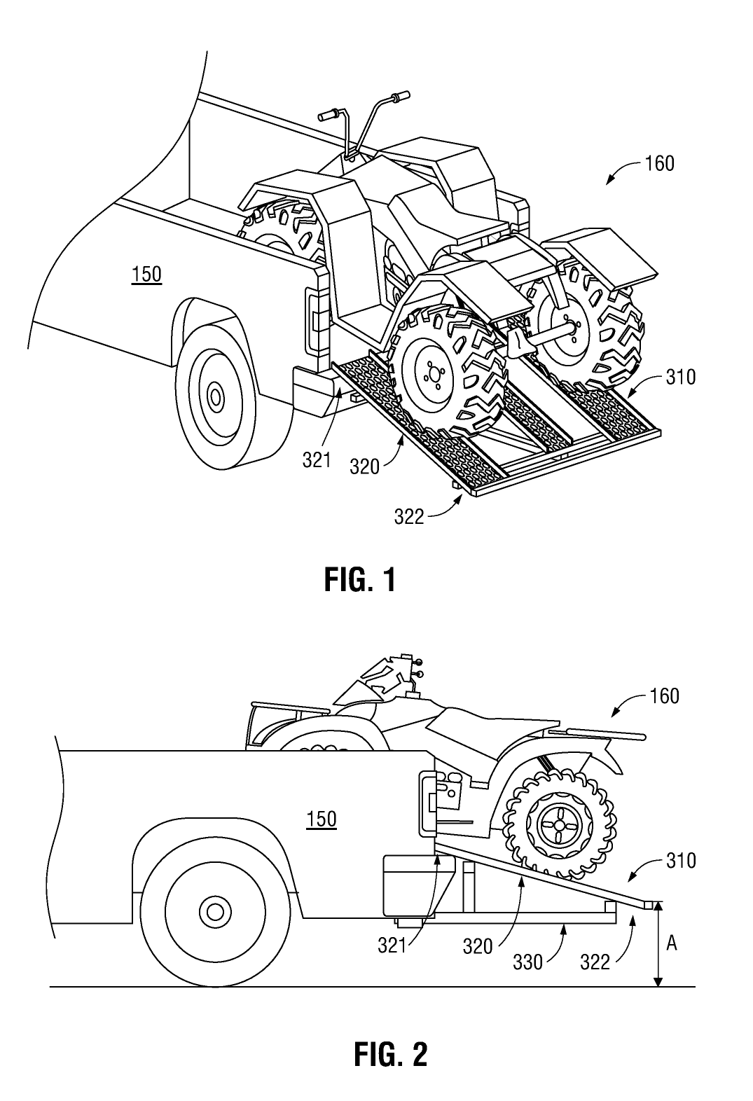

Referring now to FIG. 1, a larger vehicle 150 is shown with a vehicle transportation apparatus 310 attached and supporting a smaller vehicle 160 in accordance with one or more embodiments disclosed herein. In the example shown here, the larger vehicle 150 is a pickup truck and the smaller vehicle 160 is an all-terrain vehicle (ATV), but the principles and concepts disclosed herein may be applied to other types of larger vehicles and other types of smaller vehicles without departing from the scope of the disclosed embodiments.

As can be seen, the size of the smaller vehicle 160 and/or the bed dimensions of the larger vehicle 150 may prevent the smaller vehicle 160 from fitting fully within the bed of the larger vehicle 150. As a result, a significant portion (e.g., up to half) of the smaller vehicle 160 may precariously protrude from the larger vehicle 150, creating a potentially unstable and unsafe situation during transport.

In accordance with the disclosed embodiments, the vehicle transportation apparatus 310 may be used to support the portion of the smaller vehicle 160 that protrudes from the larger vehicle 150 in order to provide a more stable and safer way to transport the smaller vehicle 160. Such a vehicle transportation apparatus 310 may be made of any suitably strong material that can support the smaller vehicle 160, but is preferably a semi-flexible material such as lightweight steel. The vehicle transportation apparatus 310 in effect becomes an extension of the bed of the larger vehicle 150 that may be attached to and removed from the larger vehicle 150 as needed. This allows certain types of larger vehicles 150 like extended cab pickup trucks with shorter truck beds that would not otherwise be able to transport certain types of smaller vehicles 160 like ATVs and motorcycles easily and conveniently to accommodate such smaller vehicles 160. Other types of smaller vehicles 160 may include a tractor, a bicycle, a scooter, an off-road vehicle, a motorized car, a moped, a lawn mower, a snowmobile, a trailer, and the like.

In some embodiments, the vehicle transportation apparatus 310 may be composed of a generally planar, rectangular supporting structure 320 that may resemble a ramp or an inclined plane when viewed from the side. The supporting structure 320 has a first end 321 adjacent to the larger vehicle 150 and a second end 322 opposite the first end 321 that extends away from the larger vehicle 150 when the vehicle transportation apparatus 310 is mounted to the larger vehicle 150. When thus mounted, the supporting structure 320 may or may not span the entire width of the larger vehicle 150, depending on the desired transport capacity, but should be centered along a longitudinal axis of the larger vehicle 150 in order to maintain a balanced lateral weight distribution.

In preferred embodiments, the second end 322 of the supporting structure 320 is and remains suspended in the air by approximately a distance “A” above the ground when the vehicle transportation apparatus 310 is attached to the larger vehicle 150. The suspension distance “A” will of course vary during transport, but may in general be, for example, about 6 inches to about a foot or more above the ground, depending on the size and/or weight of the smaller vehicle 160 being transported by the larger vehicle 150. To facilitate loading or otherwise driving the smaller vehicle 160 up and onto the larger vehicle 150, the suspension distance “A” should be small enough so the supporting structure 320 slopes or angles down from the larger vehicle 150 toward the ground. Suspending the second end 322 of the supporting structure 320 above the ground in this way beneficially avoids having to fold up or otherwise lift the second end 322 prior to starting transport, thereby eliminating the need to provide hinges or other joints, latches or other locking mechanisms and similar components on the supporting structure 320. The larger vehicle 150 may simply drive off with the smaller vehicle 160 on board, as the supporting structure 320 does not drag along or otherwise touch the ground once it is attached to the larger vehicle 150.

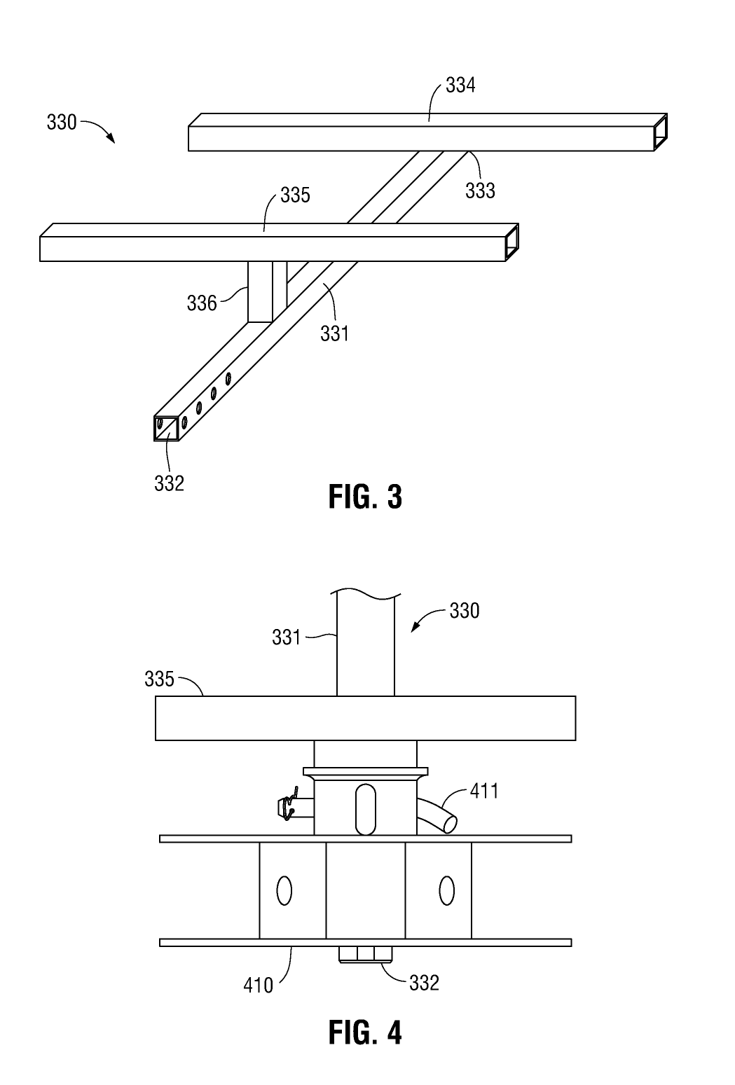

Referring to FIG. 2, the vehicle transportation apparatus 310 disclosed herein can be seen in profile. As this side view shows, the supporting structure 320 has a single gradient and is coupled to the larger vehicle 150 by an attachment mechanism 330 affixed to the underside of the supporting structure 320. In the embodiment shown here, the attachment mechanism 330 is attached in two places to the underside of the supporting structure 320, though fewer or more attachment points may certainly be used without departing from the scope of the disclosed embodiments. In addition, the attachment mechanism 330 is configured so that the second end 322 of the supporting structure 320 is suspended above the ground by the suspension distance “A” mentioned previously, imparting an angular position to the supporting structure 320. A close-up view of the attachment mechanism 330 may be seen in FIG. 3.

As FIG. 3 shows, the attachment mechanism 330 may take the form of a support strut 331 configured to provide support for the supporting structure 320 and allow it to be mounted to the larger vehicle 150. Specifically, one end of the support strut 331, namely the proximal end 332, may have a size and shape that allows it to be inserted into a standard receiver hitch 410 (see FIG. 4) on the larger vehicle 150. The other end of the support strut 331, namely the distal end 333, may be connected to a crossbeam 334 that is substantially perpendicular to the support strut 331. A mid-beam 335 may also be connected substantially perpendicular to the support strut 331 via a riser 336 extending vertically from around the middle of the support strut 331 and preferably between the middle of the support strut 331 and the proximal end 332 thereof. The crossbeam 334 and the mid-beam 335 may then be connected to the underside of the supporting structure 320 such that the crossbeam 334 provides support for the portion of the supporting structure 320 near the first end 321 thereof and the mid-beam 335 provides support for the middle portion of the supporting structure 320. Any connection technique known to those having ordinary skill in the art (e.g., welds, rivets, screws, etc.) may be used to connect the support strut 331 to the crossbeam 334 and the mid-beam 335 and likewise to connect the crossbeam 334 and the mid-beam 335 to the underside of the supporting structure 320. The proximal end 332 of the support strut 331 may then be inserted into the standard receiver hitch 410 of the larger vehicle 150 quickly and easily to attach the vehicle transportation apparatus 310 to the larger vehicle 150 as needed. Alternative connector assemblies besides the standard receiver hitch 410, such as a fixed drawbar or another appropriate method or device for connecting the attachment mechanism 330 to larger vehicle 150 may also be used without departing from the scope of the disclosed embodiments.

Referring to FIG. 4, a standard receiver hitch 410 commonly provided with most trucks and similar larger vehicles 150 is shown with the support strut 331 of the attachment mechanism 330 inserted according to the disclosed embodiments. When the attachment mechanism 330 is thus inserted, the supporting structure 320 of the vehicle transportation apparatus 310 is cantilevered from the standard receiver hitch 410 of the larger vehicle 150 insofar as the second end 322 of the supporting structure 320 does not touch the ground. Thereafter, no assembly, adjustment, storage, or removal of the vehicle transportation apparatus 310 is needed between loading, transporting, and unloading the smaller vehicle 160. A locking pin 411 may be used to secure the support strut 331 of the attachment mechanism 330 within the receiver hitch 410 in order to prevent the attachment mechanism 330 from inadvertently coming loose during transport.

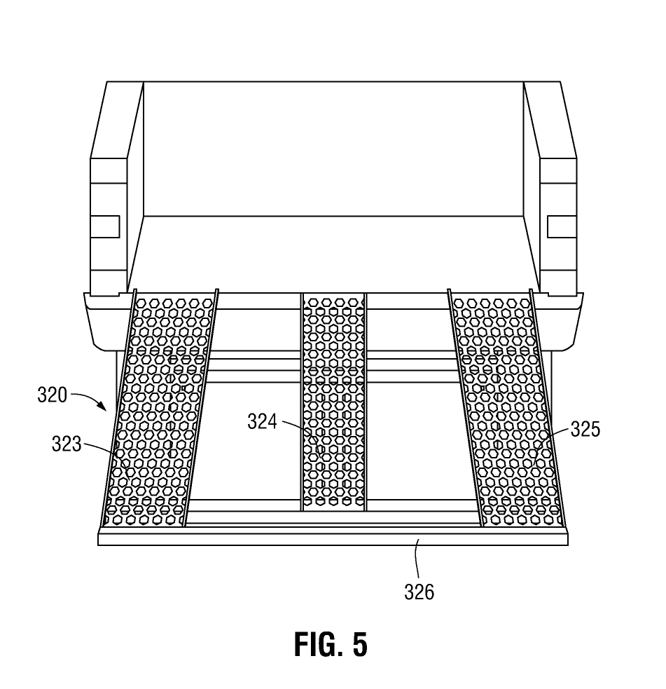

FIG. 5 shows a view of the vehicle transportation apparatus looking from the rear of the larger vehicle 150 according to the disclose embodiments. As can be seen in this view, the supporting structure 320 of the vehicle transportation apparatus may be composed of several parallel and generally planar support members 323, 324, and 325 disposed adjacent to one another. Each of the support members 323, 324, and 325 may be or have a mesh or grid-like surface, or each of the support members may have a solid surface. In the embodiment shown here, there are three individual support members 323, 324, and 325, though fewer or more support members may certainly be used without departing from the scope of the disclosed embodiments. A brace 326 may be used to connect at least two of the support members to one another, namely, the leftmost the support member 323 and the right most support member 325. The middle support member 324 may be removed in some embodiments where such a middle support member 324 is not needed for the type of smaller vehicle 160 being transported (e.g., a four-wheeled vehicle). As well, in some embodiments, the spacing between the support members 323, 324, and 325 may be adjusted along the brace 326 as needed for the type of smaller vehicle 160 being transported (e.g., an ATV versus a go-kart).

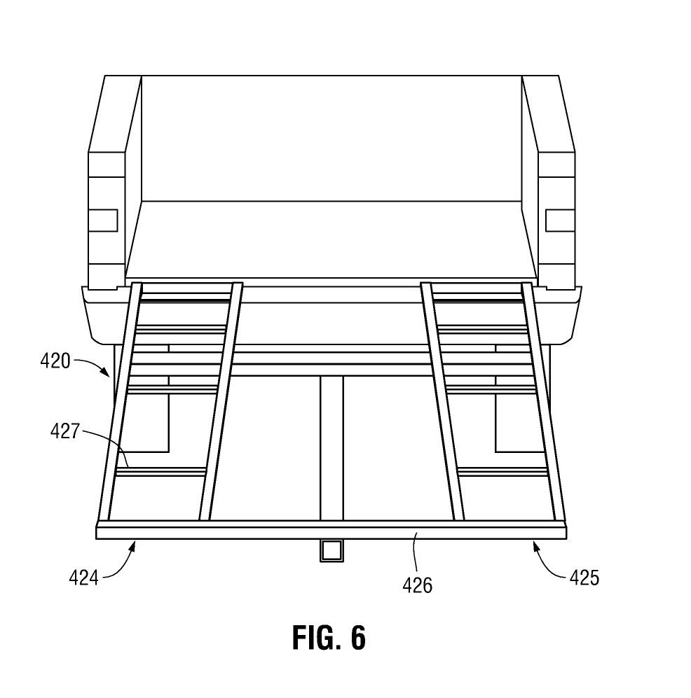

FIG. 6 shows an alternative supporting structure 420 for the vehicle transportation apparatus according to the embodiments disclosed herein, again looking from the rear of the larger vehicle 150. In this embodiment, the supporting structure 420 may be composed of two parallel and generally planar support members 424 and 425 disposed on opposite sides of the vehicle transportation apparatus 310 as shown and connected together via a brace 426. However, instead of a mesh or grid like surface, each support member 424 and 425 may resemble a ladder or a ladder like structure having a series of crossbars or steps 427 that are spaced substantially parallel and equidistance from one another. In some embodiments, the steps 427 may be constructed of angle iron in order to provide better traction for the smaller vehicle 160 when loading the smaller vehicle 160 onto the vehicle transportation apparatus. In the embodiment shown here, there are two individual support members 424 and 425, but other support members, such as a middle support member, may certainly be added without departing from the scope of the disclosed embodiments. As before, in some embodiments, the spacing between the support members 424 and 425 may be adjusted along the brace 426 as needed for the type of smaller vehicle 160 being transported.

Other alterations and modification of the disclosed embodiments will likewise become apparent to those of ordinary skill in the art upon reading the present disclosure, and it is intended that the scope of the invention disclosed herein be limited only by the broadest interpretation of the appended claims to which the inventor is legally entitled.

What is claimed is:

1. An apparatus for transporting a second vehicle using a first vehicle, the first vehicle being larger than the second vehicle, comprising:
a single-gradient, semi-flexible supporting structure having a first end and a second end opposite the first end; and
an attachment mechanism configured to couple the supporting structure to the first vehicle such that the supporting structure is at an angle with respect to the first vehicle and the ground, the first end of the supporting structure is adjacent to a back of the first vehicle, and the second end of the supporting structure is suspended above the ground, the attachment mechanism allowing the supporting structure to be removed from the larger vehicle and reattached as needed;
wherein the supporting structure, when attached by the attachment mechanism to the first vehicle, requires no further assembly or folding in order to transport the second vehicle.

2. The apparatus of claim 1 wherein the supporting structure comprises one or more support members spaced apart from one another.

3. The apparatus of claim 1 wherein the support members of the supporting structure comprise a solid surface.

4. The apparatus of claim 1 wherein the support members of the supporting structure comprise a mesh or grid-like surface.

5. The apparatus of claim 1 wherein the support members of the supporting structure comprise a ladder like structure.

6. The apparatus of claim 5 wherein one or more steps of the ladder like structure is made of angle iron.

7. The apparatus of claim 1 wherein the larger vehicle is one of: a pickup truck, an extended cab pickup truck, and a utility vehicle.

8. The apparatus of claim 1 wherein the smaller vehicle is one of: an all-terrain vehicle (ATV), a motorcycle, a tractor, a bicycle, a scooter, an off-road vehicle, a motorized car, a moped, a lawn mower, a snowmobile, and a trailer.

9. The apparatus of claim 1 wherein the attachment mechanism is coupled to a hitch of the first vehicle.

10. The apparatus of claim 10 wherein the hitch is a standard receiver type hitch of the first vehicle.
